(19) United States
(12) Patent Application Publication
(10) Pub. No.: US 2007/0135088 A1
(43) Pub. Date: Jun. 14, 2007

(54) On demand/emergency telematics & communication system

(76) Inventor: Salvatore Alessandro, Ronkonkoma, NY (US)

Correspondence Address: Salvatore Alessandro, 115 Springdale Drive, Ronkonkoma, NY, 11779, US

(21) Appl. No.: 11/297,051

(22) Filed: Dec. 8, 2005

(51) Int. Cl. H04Q 7/20

(52) U.S. Cl. 455/404.1; 455/406; 455/456.2

(57) ABSTRACT

The present invention provides On Demand/Emergency Telematics/Location-Based Services and or Wireless Communication utilizing a cellular device which is service-initialized with non-expiring but deplete-able prepaid airtime/credit, allowing transmission of calls, alarms, events, and or Telematics signals to a Private/Third-Party Remote Monitoring/Call Center (PRMC) in Emergencies or other times of need without recurring/ongoing fees for cellular lines/numbers. The system can also be activated any time after entry into service via Over The Air Activation, through service-initialization of post or pre-paid service/airtime or by porting an existing number to the system. All calls/alarms/events/transmissions requiring the PRMC to notify/contact any Public Safety/Law Enforcement Agency on behalf of the user are free of airtime and service charges. A fee is charged for all other calls/alarms/events and or services rendered by the PRMC, drawn on the prepaid airtime/credits or post billed. The system also reduces Public Safety Answering Points'/911 Emergency Response Centers' accidental/non-Emergency call/alarm rates and overall volume by allowing the management and validation of calls/alarms/events through the PRMC before reaching a PSAP/911 ERC. The system also enhances PSAP/911 ERC capabilities by providing advanced Telematics, including location and ID information, as well as providing multiple language capability by routing calls to language-specific centers or operators able to assist the user and or PSAP/911 ERC. The system also provides user privacy by On Demand activation rather than continuous “On” state activation, limiting the possibility of covert monitoring/wireless network intrusions and or retrieval/use of Telematics data not explicitly authorized by the user.

The present invention was developed for use as, but not restricted to, a Vehicular/Mobile Emergency/On-Demand Telematics, Navigation, Security and Wireless Communication System which provides Wireless Emergency/On-Demand Communication via an integrated cellular device which is Service-Initialized with Non-Expiring Prepaid but Deplete-able Airtime/Credit at entry into service, or which can be activated at a later date using Over The Air Activation (OTA) to Service-Initialize the system's integrated cellular device with post or pre-paid service, or by porting an existing number to the system's integrated cellular device.

The present invention also makes possible the reduction of accidental/false call rates/volume to Public Safety Answering Points (PSAPs)/911 Emergency Response Centers (ERC) through the validation and management of calls/alarms/events by a Private/Third-Party Remote Monitoring/Call Center (PRMC) before they reach a PSAP/911 ERC, and also enhances PSAPs/911 ERCs' capabilities by providing advanced Telematics/Location/ID and multiple language capabilities in Emergencies requiring the notification and or intervention of a PSAP/911 ERC or any Public Safety or Law Enforcement Agency/Authority, as well as protecting the privacy of users by making the system available On Demand.

The present invention also envisions using existing or additional Emergency/Priority Access Channel/s in the absence of Commercial cellular service and or allocation of distinct Emergency/Priority Channels used to route calls/alarms to PRMCs for validation before being forwarded to a Public Safety Answering Point (PSAP)/911 Emergency Response/Call Center (ERC).

### STATEMENT REGARDING FEDERALLY FUNDED RESEARCH OR DEVELOPMENT

The present invention has been developed without federally funded research or development.

### BACKGROUND OF THE INVENTION—TECHNICAL FIELD

The present invention is an Emergency and or On-Demand Wireless Communication and or Telematics System with Emergency Call/Alarm/Event Validation, Management, and Enhanced Services for, but not limited to, vehicles, assets, persons, or any target necessitating the use of wireless communication networks to transmit alarms/events, data, or communication.

### BACKGROUND—DESCRIPTION OF PRIOR ART

Vehicular/Mobile Location-Based Services (LBS) have proliferated due to consumers' growing awareness of the usefulness and potentially life-saving benefits of advanced Telematics/Location-Based technologies such as GPS. Inasmuch as location/tracking technology such as the Global Positioning System (GPS) is made available to the public free of charge, Telematics Systems rely on commercial wireless networks to transmit GPS Data to Remote/Third-Party Locations, thus limiting critical services and aid in Emergencies or instances of need to those with the financial means to maintain a commercial wireless/cellular line intended for use in Emergencies or other cases of need.

Efforts have been made to make Location/Telematics Technologies available in emergencies even without commercial network service, ie., 911 Phones/E-Call, mandated Emergency/Priority Access/911 Wireless Communication Channels, as well as Automatic Location Identification (ALI) and Caller Identification (CID) requirements of Enhanced 911 legislation, however, these are limited to cell-phone handsets and are further limited by the lack of Telematics/GPS and sometimes even ALI/CID capabilities on the part of Public Safety Answering Points (PSAPs)/911-Emergency Response Centers, Network Operators/Carriers, and the Wireless Network itself when used for location purposes. Additionally, the prior art technology does not address the increased call volume to PSAPs/911 Response Centers, as well as accidental calls/false alarms and or misuse/abuse of PSAPs, which has led Police/Authorities in certain jurisdictions to no longer respond to some alarms, and in some cases making false alarms, even when triggered by automated systems, a civil or criminal offense.

Prior art technology also does not address privacy issues relating to covert monitoring of individuals using public wireless networks as well as non-English speaking persons needing Emergency/911 assistance in the US/North America.

### BRIEF SUMMARY OF THE INVENTION

The object and advantage of the present invention is to provide Wireless Communication and Telematics/Location-Based Services at any time and affordably for use in Emergencies or other cases of need On Demand, without recurring wireless/cellular communication/line costs. This is achieved by loading the system's integrated cellular device (ICD) with non-expiring but deplete-able prepaid airtime at the time the system is entered into service/activated, which makes possible system transmission of both Actively triggered (user-initiated) and Passively triggered (automatic system response) calls/alarms/events at any time. The system can also be activated by Over The Air Activation (OTA) of the ICD to port an existing number to the ICD or to service-initialize the ICD with post or prepaid service in order to make Telematics or Communication service/s available in Emergencies or when otherwise needed, ie., to locate a stolen vehicle/asset or locate or communicate with a person/vehicle occupant. Calls/alarms/events are transmitted to and managed by the Private Remote Call/Monitoring Center (PRMC), and those validated by the PMRC as Emergencies then relayed to a PSAP/911 ERC for response.

A further object and advantage of the present invention is a reduction of accidental/non-emergency call rates/volume to PSAPs/911 ERCs by validating Emergency calls/alarms/events through the PRMC before relaying a call/alarm/event to PSAPs/911 ERCs on behalf of the user. The present invention also provides expanded Telematics/Location/ID capabilities to PSAPs/911 ERCs in instances where the PSAP/911 ERC does not have such capabilities, and also discourages misuse/abuse of Emergency Call service and PSAPs/911 ERCs facilities by charging a fee/s drawn on the system's prepaid airtime/credit or post-billed for calls received and or service/s provided by the PRMC for calls/events/alarms which are not validated Emergencies requiring the notification of PSAPs/911 ERCs or the intervention of Public Safety/Law Enforcement Agencies.

The present invention also employs software which routes calls to a PRMC operator or call center fluent in a specified language based on user-specified language preference/s and addresses privacy concerns related to location and or cellular devices where legal precedent has established the presumption that users of wireless communication networks/facilities forfeit privacy, by making the system available ‘On Demand’ whereby the system is activate-able at any time and or only when specified or requested by the subscriber/user, whether passively or actively (ie. Passively, Automatic Crash Notification, which is triggered by the system without user/subscriber input, or Actively such as a Panic Alarm, triggered by user/subscriber input).

### DETAILED DESCRIPTION OF THE INVENTION—DESCRIPTION OF THE PREFERRED Embodiment

In the prior art, Telematics services/devices have required the user to maintain a wireless/cellular line for data and or voice transmissions via wireless network. The inherent cost of maintaining a cellular line/number however, have restricted the use of potentially life-saving Wireless Communication and Telematics technology in Emergencies.

The present invention differs from prior art technology by making possible the use of location systems/GPS and wireless communication at any time, particularly in Emergencies, without the recurring costs associated with keeping a wireless/cellular line active.

Instances in which the present invention can be used to provide Emergency Services include;

Emergency Cellular Communication, actively triggered/activated by the user, passively triggered/activated by the system, ie., Automatic Crash Notifcation, or remotely triggered/activated by the PRMC

Emergency Navigation, actively triggered by the user to obtain directions remotely from the PRMC, ie., to reach the nearest hospital in medical emergencies

Automatic Crash Notification of a Vehicle, passively/automatically triggered by the system to send the PRMC an alarm/crash notification along with the location/ID of the vehicle/user when the system's sensors detect either a crash or violent/abrupt change of position

Emergency Vehicle Diagnostics Notification, passively triggered by the system to alert the user/subscriber of vehicle condition/s requiring attention, or actively triggered by user/subscriber or PRMC to obtain or update status

Panic/Distress/SOS Notification with Location/ID, ie., actively triggered by the user to alert the PRMC of Emergencies requiring urgent assistance

Geo-Fence Violation Alert, passively/automatically triggered by the system to send the PRMC an alert/alarm when a Vehicle, Asset, Person, or other Mobile Target travels out of or is taken beyond a preset geographical area/perimeter.

Intrusion Alert, passively/automatically triggered by the system to send the PRMC an alert/alarm when a vehicle or asset fitted with either a motion, microwave, sound or similar sensor detects any kind of unauthorized entry/use

Locating a Vehicle, Asset, or Person, or other Mobile Target at any time, actively triggered by the user/subscriber, ie., to track a stolen or missing vehicle, asset, person, or other mobile target

Sending a command to a Vehicle/Asset/Mobile Target, actively triggered by the user/subscriber, ie., to unlock vehicle doors in case of lock-out

Wireless service for system-generated (passively triggered) or user/subscriber-generated calls/alarms/events is achieved by activating the system's integrated cellular device (ICD) at the time of installation in the mobile target such as vehicle, asset, mobile device or other target, with re-loadable pre-paid airtime/credits which are non-expiring but deplete-able. Wireless service for user/subscriber-generated (actively triggered) calls/alarms/events can also be achieved any time thereafter via Over The Air Activation (OTA) with post or pre-paid Service Initialization or via Local Number Portability (LNP) by porting an existing number to the system's ICD over the air, thus allowing the system to be used On-Demand for non-emergency use, with non-emergency airtime/services charged/billed as used and Emergency calls/alarms/events requiring the PRMC to contact a PSAP/911 ERC or Public Safety/Law Enforcement Agency on behalf of the user remaining free of service and airtime charges.

In the event prepaid airtime/credits are drawn-down by use of the system for non-Emergency calls/alerts/events, the user is notified of the need to reload the system with airtime/credits to assure non-Emergency calls/requests/transmissions, ie., vehicle position requests, remote commands, will be accepted, however, Emergency calls/alarms/events/transmissions requiring the PRMC to contact a PSAP/911 ERC or Public Safety/Law Enforcement Agency on behalf of the user will continue to be transmitted, free of service and airtime charges.

In the case of a system with no previous service initialization; depleted, or deactivated cellular service, or if the receiving private party does not respond, the present invention also envisions setting the cellular transceiver to default-dial a preset Emergency Channel to assure that emergency calls/events/alarms/transmissions passively triggered by the system (ie. vehicle crash/airbag deployment), or actively triggered by an occupant (ie., activation of the panic/distress button, or voice/password—activated alarm) are transmitted at all times, irrespective of user status with the cellular network provider and or PRMC.

The system's integrated cellular device can be configured for regional service with non-roaming cellular service or with full roaming capabilities including tri-band/multi-network cellular transceiver to provide expanded coverage nationally and internationally as well as choice of carriers and or commercial service/rates.

The present invention expands and enhances PSAP/911 Emergency Response Center effectiveness and capabilities in that by making commercial Telematics and wireless communication available On Demand, Emergency calls/alarms/events generated by the system or a user/subscriber can first be routed to a Private/Third-Party Remote Monitoring/Call Center/Location, which validates the call/event/alarm/transmission, then relays validated Emergencies to the PSAP/911 ERC with Enhanced Telematics/ID data whenever applicable. All other calls/alarms/events/transmissions are managed by the PRMC, thus reducing call-loads to PSAPs/911 ERCs. By screening and managing non-Emergency calls/alarms/events and drawing on the system's prepaid airtime/credits or billing the user/subscriber for airtime and or services provided by the PRMC and or Network Operator for calls/alarms/events/transmissions which are not validated emergencies requiring the notification of PSAPs/911 ERCs and or the intervention of Public Safety/Law Enforcement Agencies, the present invention also reduces false alarms, accidental/non-emergency calls, and misuse of Public Emergency Call facilities.

The present invention also envisions using existing or additional Wireless Emergency/Priority Access Channel/s to route Emergency calls generated by the system or system user. Using existing channels would allow PSAPs/911 ERCs to receive system alarms/calls and use ALI/CID whenever possible for location and identification. By adding Emergency/Priority Channel/s, calls/alarms generated by the system would be transmitted via the new channel/s to a PRMC first for validation, and once validated then forwarded to the PSAP/911 ERC with all corresponding system-generated Telematics, ie., location, user ID.

The present invention also envisions allocation of multiple emergency/priority channels used to distinguish different types of events such as calls/alarms generated by vehicle crash, Panic Alarms/SOS alarms, etc.

System Hardware Includes;

A. Control Module

B. Cellular Transceiver

C. GPS (integrated chip or modular receiver)

D. Modem

E. Hands-free cellular voice kit

F. Independent Power Supply

G. Panic/Distress Button

H. Crash Sensor

I. Additional Sensors include Door Lock/Unlock, Microwave/Volumetric, Motion, Sound, Vehicle Immobilizer/Transponder

The system's components can be added or omitted and or enabled or disabled upon system activation or installation depending on wireless market, wireless network type and availability, Police/911/119/Emergency Channel availability, private monitoring availability, and or user preferences.

1. Provides Wireless Communication and or Telematics/Location-Based Services in Emergencies or other cases of need without recurring wireless/cellular communication/line costs by utilizing an integrated cellular device which is Service-Initialized with Non-Expiring, Prepaid but Deplete-able Airtime/Credit to allow transmission of passively and or actively triggered calls, alarms, and or events at any time; or which can be activated at a later date using Over The Air Activation (OTA) to Service-lnitialize the system's integrated cellular device with post or pre-paid service, or by porting an existing number to the system's integrated cellular device to allow transmission of calls, alarms, events, and or GPS/Telematics data to a Remote Monitoring/Answering Point in emergencies or other events triggered either passively or actively by a user/occupant, or remotely by authorized party.

2. Reduces PSAP/911 ERC false alarms, non-emergency calls, abuse and call rates/loads by allowing Private Remote Monitoring/Call Centers (PRMCs) to validate calls/alarms/events before contact is made with a PSAP/911 ERC whenever possible, and by imposing a fee on non-emergency calls/alarms/events, while enhancing PSAP/911 ERC capabilities in validated emergencies by providing PSAPs/911 ERCs with advanced Telematics/Location and ID data as well as multiple language capability by routing calls to operators or call centers proficient in a user-specified language whenever possible and or providing translation assistance between PSAPs/911 ERCs and non-English speaking users.

3. Provides privacy by making the system activate-able at any time rather than being in a continuous “On” state, limiting possible exposure to covert monitoring/intrusion, and or collection/retrieval of Telematics data not explicitly authorized by the user/subscriber.
